(19) United States
(12) Patent Application Publication
(10) Pub. No.: US 2026/0146981 A1
(43) Pub. Date: May 28, 2026

(54) AUTOMATIC TUNING OF A RIG SITE GAS CHROMATOGRAPH

(71) Applicant: Schlumberger Technology Corporation, Sugar Land, TX (US)

(72) Inventors: Elena Borisova, Paris (FR); Jean-Pierre Bailly, Clamart (FR)

(21) Appl. No.: 19/265,719

(22) Filed: Jul. 10, 2025

(30) Foreign Application Priority Data
Nov. 25, 2024 (EP) 24306972.1

(51) Int. Cl. G01N 30/86; G01N 30/02; G01N 30/32; G01N 30/40; G01N 30/88

(52) U.S. Cl. CPC G01N 30/8655; G01N 30/32; G01N 30/40; G01N 30/88; G01N 2030/025; G01N 2030/324; G01N 2030/8854

(57) ABSTRACT

A method for tuning a rig site gas chromatography apparatus includes acquiring a chromatogram of a gas sample using a rig site GC apparatus at a nominal column temperature and a nominal carrier gas flow rate. The gas sample includes at least first and second light alkane gases (C1 and Cn). C1 and Cn elution times are extracted from the obtained chromatogram. An optimum column temperature is determined from the nominal column temperature and the extracted C1 and Cn elution times. An optimum carrier gas flow rate is determined from the nominal carrier gas flow rate, the nominal column temperature, the computed optimum column temperature, and the extracted C1 elution time. The GC apparatus is then configured to make GC measurements using the computed optimum column temperature and the computed optimum carrier gas flow rate.

### CROSS REFERENCE TO RELATED APPLICATIONS

This application claims the benefit of EP Application Serial No. 24306972.1 entitled “AUTOMATIC TUNING OF A RIG SITE GAS CHROMATOGRAPHY” filed Nov. 25, 2024, the disclosure of which is incorporated herein by reference in its entirety.

### BACKGROUND

When drilling a subterranean wellbore, circulating drilling fluid commonly carries formation fluids and dissolved formation gasses to the surface. Such gasses may be liberated by the drill bit as it cuts the formation and may include various alkane gasses such as methane (C1), ethane (C2), propane (C3), butane (C4), pentane (C5), and the like, as well as alkenes and alcohols. The liberated gas stream is commonly evaluated at the surface while drilling to determine the composition of the dissolved gases in the drilling fluid. Such measurements may provide valuable information to a mud logger and may provide information about the maturity and nature of hydrocarbons in the reservoir, compartmentalization of intervals in the reservoir being drilled, and oil quality, as well as information regarding production zones, lithology changes, history of reservoir accumulation, or seal effectiveness.

Gas chromatography (GC) is often used to separate and analyze the liberated gases. In some operations, continuous measurements are made while drilling with the intent being to quantify the light hydrocarbon compounds (e.g., alkane gases from C1 to C5 or from C1 to C8 for an enriched and more complete analysis). Parametrization of the GC equipment is often performed manually in the field by adjusting the pressure regulators, needle valves, and set point of the GC oven. These adjustments are needed to achieve optimal chromatographic resolution for given equipment, the type of chromatographic analysis, the gases present in the gas stream, and process conditions. The parameterization and adjustments are time consuming and required highly skilled GC personnel. Such personnel are commonly not available at the rig site. Moreover, even when available, the resulting parameterization and adjustments can be operator-dependent and prone to human errors.

There is a need in the industry for improved GC parameterization methods, particularly automated methods that may be implemented at the rig site.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including a disclosed gas chromatography apparatus.

FIG. 2 depicts another view of a portion of the surface system shown on FIG. 1.

FIG. 3 depicts an example gas chromatography apparatus.

FIG. 4 depicts an example column assembly in which multiple columns are coupled with a multiport valve.

FIG. 5 depicts a block diagram of an example GC apparatus including the column assembly shown on FIG. 4.

FIG. 6 depicts a schematic of the GC apparatus shown on FIG. 5.

FIG. 7 depicts a flow chart of one example method for tuning a GC apparatus.

FIG. 8 depicts a flow chart of another example method for tuning a GC apparatus.

FIG. 9 depicts a flow chart of a method for performing a quality control check of computed GC parameters.

FIGS. 10A and 10B depict example chromatograms obtained with corresponding gas samples including C1-C5 alkane gases (10A) and C1-C8 alkane gases (10B).

### DETAILED DESCRIPTION

Methods and systems for parameterizing (or tuning) a gas chromatography apparatus at a rig site are disclosed. One example method embodiment includes acquiring a chromatogram of a gas sample using a rig site GC apparatus at a nominal column temperature and a nominal carrier gas flow rate. The gas sample includes at least first and second light alkane gases (C1 and Cn). C1 and Cn elution times are extracted from the obtained chromatogram. An optimum column temperature is determined from the nominal column temperature and the extracted C1 and Cn elution times. An optimum carrier gas flow rate is determined from the nominal carrier gas flow rate, the nominal column temperature, the computed optimum column temperature, and the extracted C1 elution time. The GC apparatus is then configured to make GC measurements using the computed optimum column temperature and the computed optimum carrier gas flow rate.

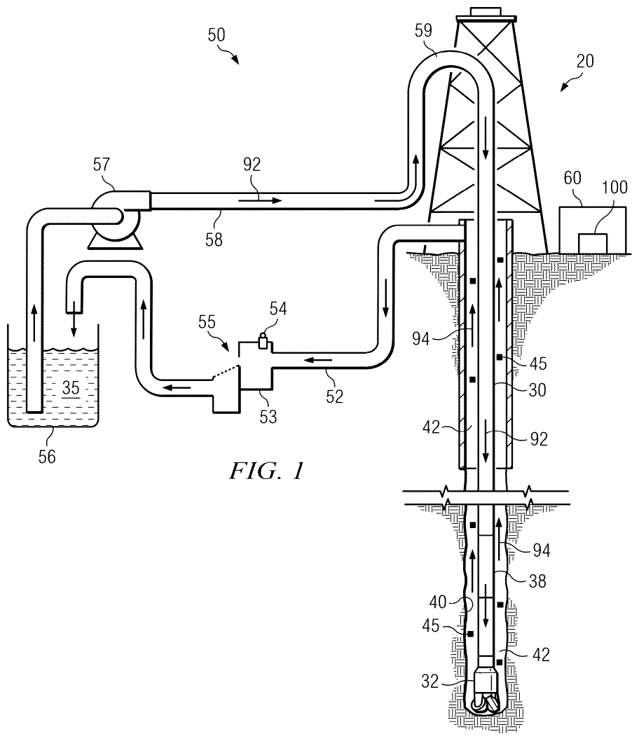

FIG. 1 depicts an example drilling rig 20 including a disclosed GC apparatus 100 that may be configured to automatically perform a parameterization at the rig site. The drilling rig 20 may be positioned over a subterranean formation (not shown). The rig 20 may include, for example, a derrick and a hoisting apparatus (also not shown) for raising and lowering a drill string 30, which, as shown, extends into wellbore 40 and includes, for example, a drill bit 32 and one or more downhole measurement tools 38 (e.g., a logging while drilling tool or a measurement while drilling tool) in a bottom hole assembly (BHA) above the bit 32. The BHA may of course include other tools, for example, including a steering tool such as a rotary steerable tool and a mud motor. The disclosed embodiments are not limited to any particular BHA configuration.

Drilling rig 20 further includes a surface system 50 for controlling the flow of drilling fluid used on the rig (e.g., used in drilling the wellbore 40). In the example rig depicted, drilling fluid 35 may be pumped downhole (as depicted at 92), for example, via a conventional mud pump 57. The drilling fluid 35 may be pumped, for example, through a standpipe 58 and mud hose 59 in route to the drill string 30. The drilling fluid 35 typically emerges from the drill string 30 at or near the drill bit 32 and creates an upward flow 94 of mud through the wellbore annulus 42 (the annular space between the drill string and the wellbore wall). The drilling fluid 35 then flows through a return conduit 52 to a mud pit system 56 where it may be recirculated. It will be appreciated that the terms drilling fluid and mud are used synonymously herein.

The circulating drilling fluid 35 is intended to perform many functions during a drilling operation, one of which is to carrying drill cuttings 45 to the surface (in upward flow 94). The drill cuttings 45 are commonly removed from the returning mud via a shale shaker 55 (or other similar solids control equipment) in the return conduit (e.g., immediately upstream of the mud pits 56).

Gases that are released or generated during drilling may also be carried to the surface in the circulating drilling fluid 35. As is known to those of ordinary skill in the art, formation gas may be released into the wellbore 40 via the drilling process (e.g., crushing the formation rock by the mechanical action of the drill bit) and may also migrate into the wellbore 40, for example, via fractures in the formation rock. The drilling process may also generate gases, for example, via drill bit metamorphism (DBM). Once in the wellbore, the gases may be transported to the surface via the drilling fluid (in the upwardly flowing fluid 94). These gasses, which may be dissolved in the mud or in the form of bubbles, are commonly removed from the drilling fluid, for example, via one or more degassers 54 located in or near a header tank 53 that is immediately upstream of the shale shaker 55 in the example depiction. It will be appreciated that the disclosed embodiments are not limited in regards to how the gas is sampled. The drill cuttings 45 and the extracted gases are commonly examined at the surface to assist the drilling operation and to evaluate the formation layers and the reservoir though which the wellbore is drilled.

With further reference to FIG. 1, drilling rig 20 may further include a testing facility 60 (e.g., a mud logging system or a laboratory trailer including one or more instruments suitable for making various measurements of sampled gases in the drilling fluid). In the depicted embodiment, the testing facility 60 includes a GC instrument 100 that is configured to measure the formation gas composition. The testing facility 60 may, of course, include numerous other testing instruments known to those of ordinary skill.

It will of course be appreciated that while FIG. 1 depicts a land rig 20, that the disclosed embodiments are equally well suited for land rigs or offshore rigs. As is known to those of ordinary skill, offshore rigs commonly include a platform deployed atop a riser that extends from the sea floor to the surface. The drill string extends downward from the platform, through the riser, and into the wellbore through a blowout preventer (BOP) located on the sea floor. The disclosed embodiments are expressly not limited in these regards.

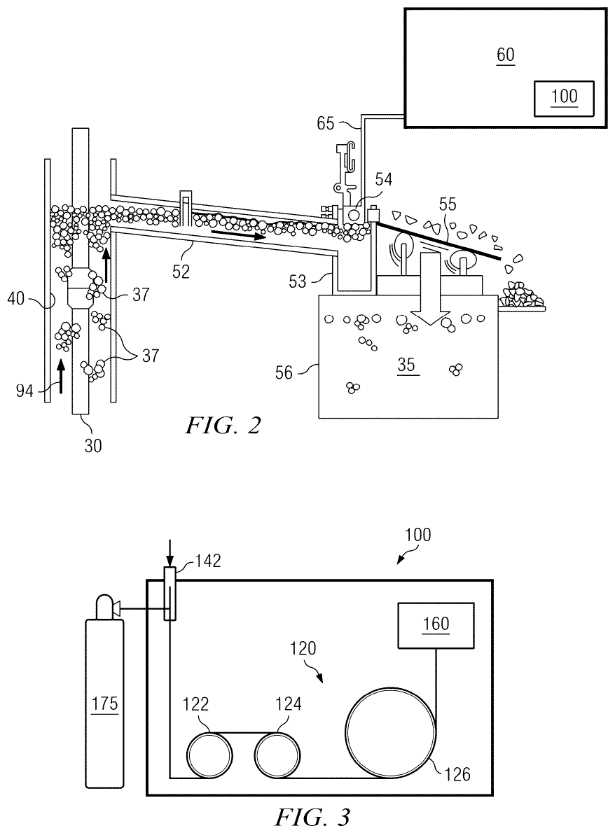

FIG. 2 depicts another view of a portion of surface system 50. As described above, the return conduit 52 is configured to carry drilling fluid 35 (sometimes including gas bubbles 37) from wellbore 40 to mud pit 56. The example system 50 includes a degasser 54 deployed, for example, in or near a header tank 53 that is immediately upstream of the shale shaker 55 and mud pit 56. In this example configuration, the degasser 54 is configured to remove gases in the drilling fluid that emerges from the wellbore 40 (referred to in the industry as gas-out). It will be appreciated that the disclosed embodiments are not limited in this regard. For example, the degasser 54 may include first and second degassers, the first configured to make gas-out measurements and the second deployed downstream of the mud pump so as to make gas-in measurements.

It will be further appreciated that the disclosed embodiments are not limited to the use of a degasser as depicted. Alternative embodiments may also (or additionally) make use of a gas probe located in the conduit 52 or at the surface of the well 40. In example embodiments, the degasser (or degassers) 54 may be piped directly to the mud logging unit or rig laboratory 60 (e.g. as depicted at 65), for example, to automatically transport the sampled gases for compositional testing.

It will be appreciated that system 50 may include substantially any suitable degasser (or degassers) 54, for example, including a vacuum degasser, a centrifugal degasser, and an impeller degasser. The degasser 54 may further be configured to heat the drilling fluid 35 to promote enhanced degassing of the fluid. The disclosed embodiments are not limited in regard to the type of degasser employed. Moreover, while not depicted, the system 50 may include one or more pumps (e.g., suction or pressure boosting pumps) configured to pump sampled gas from the degasser(s) 54 and/or the gas probe to the laboratory 60. The disclosed embodiments are, of course, not limited in regards to any sampling, pumping, or gas transport configurations.

FIG. 3 depicts an example GC apparatus 100 including a gas sample injection port 142 configured to feed a gas sample into an example column assembly 120 including a precut column 124 and a main GC column 126. The GC apparatus 100 further includes a carrier gas supply 175, such as a supply of compressed nitrogen, argon, helium, or air. An injected gas sample may be mixed with the carrier gas and transported through the column assembly 120. The GC apparatus may further optionally include a trapping column 122 in series with the precut column and configured to remove interfering compounds in the gas stream such as alcohols. The precut column 124 may be configured to remove heavier hydrocarbon compounds having a number of carbon atoms above a threshold, such as C6, C8, or C10 and above. The main column 126 includes a stationary phase and may be configured to separate the various gas compounds in the gas sample such that they arrive at the detector 160 at distinct elution times, for example, such that C1 arrives before C2, which arrives before C3, and so on. The detector may include substantially any suitable GC detector, such as a flame ionization detector (an FID detector), a TC detector, or a mass spectrometer. Moreover, while example GC apparatus 100 includes a trapping column 122 and a precut column 124, it will be appreciated that the disclosed embodiments are not limited in this regard. The disclosed embodiments are equally well suited for a GC apparatus including only a main column or a GC apparatus including a main column and a precut column.

FIG. 4 depicts an example column assembly 120 (e.g., including a main column and a precut column) deployed about a mandrel 121 (the columns are not depicted individually in this figure). The columns are in fluid communication with a multiport (e.g., 10 port) valve 128. As described in more detail below, the multiport valve 128 enables the gas sample to be routed through the various columns to the detector 160 (FIG. 2). The depicted column assembly 120 may further optionally include one or more heating elements (also not shown) deployed on the mandrel 121. The heating element(s) may enable the temperature of the mandrel and the columns to be controlled and/or held, for example, at any temperature up to about 200 degrees C.

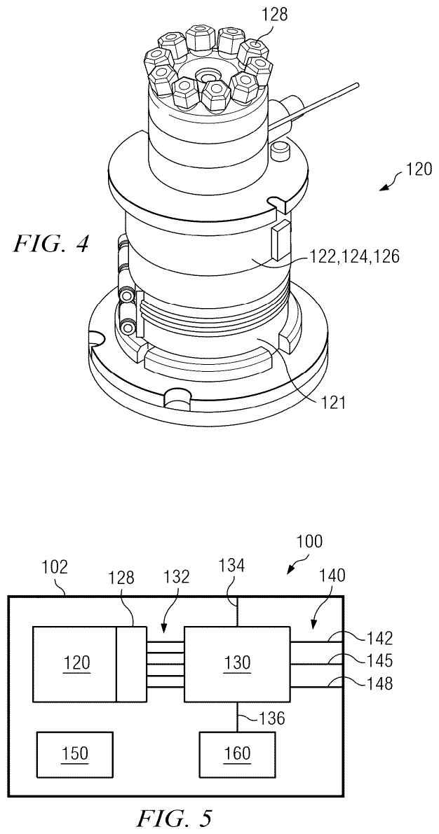

FIG. 5 depicts a block diagram of example GC apparatus 100 including the column assembly 120 shown on FIG. 3. As depicted, the column assembly is deployed in the GC housing 102. The apparatus further includes a flow manifold 130 in fluid communication with the multiport valve 128. The flow manifold 130 may include, for example, a number of controllable valves, pressure regulators, and flow regulators (not shown). In the depicted embodiment, the flow manifold is in fluid communication with the multiport valve 128 via a plurality of flow passageways at 132, an external vent at 134, a plurality of gas inlet ports at 140, and the GC detector 160 at 136. The inlet ports may include for example, a gas sample injection port 142, a carrier gas injection port 145, and a reverse flow injection port 148.

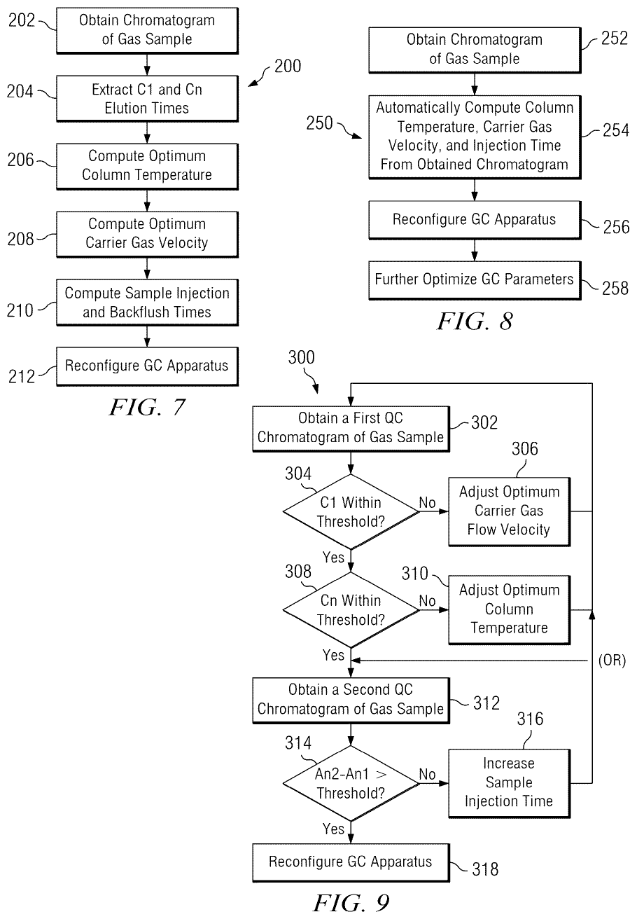

GC apparatus 100 may further include an electronic controller 150 configured to control the detector 160, the flow manifold 130, the injection ports, and the position of the multiport valve 128. The controller 150 may be further configured to execute methods 200, 250, and 300 described in more detail below with respect to FIGS. 7, 8, and 9. It will, of course, be appreciated that the controller may include computer hardware and software configured to cause the GC apparatus to perform the above described functions. The hardware may include one or more processors (e.g., microprocessors) which may be connected to one or more data storage devices (e.g., hard drives or solid state memory) and user interfaces. It will be further understood that the disclosed embodiments may include processor executable instructions stored in the data storage device. The disclosed embodiments are, of course, not limited to the use of or the configuration of any particular computer hardware and/or software.

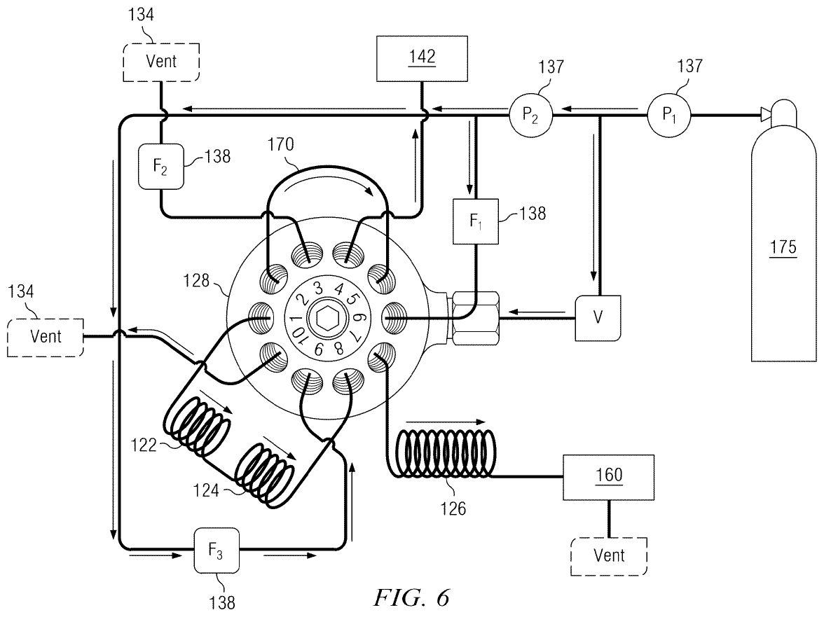

FIG. 6 depicts a schematic of the GC apparatus shown on FIG. 5. As depicted, in this example embodiment, the trapping column 122, the precut column 124, and the main column 126 are in fluid communication with the multiport valve 128. In particular, the trapping column 122 and precut column 124 are coupled in series and are in fluid communication with ports 1 and 8 of the multiport valve 128. The main column 126 is in fluid communication with port 7 and the detector 160. The carrier gas supply 175 is in fluid communication with ports 6 and 9 in this particular embodiment. In alternative embodiments, the carrier gas supply may be fluid communication with port 6 and a separate gas supply (such as a backflush gas) may be in fluid communication with port 9. The gas sample injection port 142 is in fluid communication with port 4. A sample collection loop 170 is in fluid communication with ports 2 and 5. Ports 3 and 10 are vented. The example GC apparatus 100 depicted further includes a plurality of pressure regulators 137 and flow regulators 138, as well as vent lines 134.

As is evident in FIGS. 3-6, a rig-site GC analyzer (such as GC apparatus 100 in FIGS. 3-6) is a complex instrument. In GC measurements, process parameters, such as carrier gas flow rate, column temperature, and injection and back-flush times, are adjusted to achieve the elution of all target components (e.g., C1 to C5 or C1 to C8) within a specified cycle-time. Commercial GC instruments used on a rig have standard hardware configuration, however, the optimal settings commonly differ from one analyzer to another (despite having identical nominal settings). For example, manufacturing variability, aging of the GC column, and supply gas quality can influence the optimal settings.

One example of manufacturing variability is the effective cross-section of the GC columns, which can differ from one column to the next (or from one lot of columns to the next). Nominally identical columns having the same column length (and model number) operated under the same conditions (including the same carrier gas, gas flow rate, and temperature) generally have different elution times for gases of interest in oilfield GC measurements (such as C1 to C5 or C1 to C8). Generally, the carrier gas rate must be adjusted in order to achieve comparable elution times.

Another example of manufacturing variability is inconsistent column coating thicknesses, typical for porous-layer open-tubular (PLOT) columns. Such variability can cause carrier gas flow differences as well as retention differences from column to column. Moreover, the quality of carrier gas supply (especially when air is used as the carrier gas) and column aging may significantly influence column retention and the observed elution times. Adjustments are commonly made to the carrier gas flow rate and column temperature during the lifecycle of the analyzers. Adjustments are also sometimes made to the injection and backflush times to obtain the specified elution times. As noted previously, these adjustments are time consuming and generally require highly trained personnel. There is a need in the industry for parameterization methods (particularly automated methods) to obtain chromatograms having prespecified elution characteristics for oilfield gases of interest.

Turning now to FIG. 7, a flow chart of one example GC parameterization method (a method for tuning a GC apparatus) 200 is depicted. The method includes obtaining a chromatogram for a gas sample at nominal column temperature and carrier gas flow rate settings at 202. The gas sample may be a calibration sample, for example, including various alkane gases of interest. For example, the gas sample may be a calibration sample including a standard calibration mixture of C1 through C5 gases such as C1, C2, C3, iC4, nC4, iC5, and nC5 gases. In another example, the gas sample may be a calibration sample including a standard calibration mixture of C1 through C8 gases such as C1, C2, C3, iC4, nC4, iC5, nC5, nC6, benzene, nC7, toluene, and nC8. Those of ordinary skill will readily appreciate that in such gas nomenclature the numeral represents the number of carbon atoms in the alkane gas. In advantageous embodiments, the gas sample includes at least C1 and Cn gases, where n is 5, 6, 7, or 8. The chromatogram may be obtained by setting the carrier gas flow rate (e.g., as measured using a mass flow meter) and the column temperature to the nominal settings and injecting the gas sample into the column assembly (e.g., via injection port 142 in FIG. 3). The detector output may then be plotted with time to provide the chromatogram.

The elution times

$${t}_{C 1}^{0} and {t}_{C n}^{0}$$

of C1 and on at the nominal GC settings may be extracted from the obtained chromatogram at 204, for example, using peak extraction techniques known to those of ordinary skill in the art. An optimum column temperature may then be computed at 206 from the extracted C1 and Cn elution times. For example only, a nominal retention coefficient k⁰ may be computed according to the following mathematical relation:

$${k}^{0} = \frac{{t}_{Cn}^{0} - {t}_{C 1}^{0}}{{t}_{C 1}^{0}} \qquad ( 1 )$$

The optimum temperature Tₒₚₜ may be computed, for example, according to the following mathematical relation:

$${T}_{opt} = \frac{1}{\frac{ln ( k ) - ln ( {k}^{0} )}{a} + \frac{1}{{T}^{0}}} \qquad ( 2 )$$

where T⁰ represents the nominal temperature, a is a known constant, and k represents a desired retention coefficient, which may be given as follows:

$$k = \frac{{t}_{C n} - {t}_{C 1}}{{t}_{C 1}} \qquad ( 3 )$$

where t_{C1} and t_{Cn} represent desired elution times for the C1 and Cn gases in the gas sample.

An optimum carrier gas flow rate may be computed from the nominal carrier gas flow rate, the computed optimum temperature, and the nominal temperature at 208. In example embodiments, a ratio of the optimum carrier gas flow rate to the nominal carrier gas flow rate may be inversely related to a ratio of the optimal temperature to the nominal temperature. In example embodiments the ratio of the optimum carrier gas flow rate to the nominal carrier gas flow rate may also be inversely related to a ratio of the desired C1 elution time to the measured C1 elution times in the chromatogram obtained at 202. The optimum carrier gas flow rate Vₒₚₜ may be computed, for example, according to the following mathematical relation:

$${V}_{opt} = {{V}^{0} ( \frac{{T}^{0}}{{T}_{opt}} \frac{{t}_{C 1}^{0}}{{t}_{C 1}} )}^{n} \qquad ( 4 )$$

where n is a constant related to a configuration of the GC apparatus and may be determined, for example, empirically acquiring two or more chromatograms at a constant temperature and correspondingly distinct flow rates. In common GC apparatuses used in oilfield applications 1≤n≤2.

With continued reference to FIG. 7, method 200 may further optionally include computing optimum gas sample injection and backflush times for the GC measurements at 210. In example embodiments, the optimum injection time t_{INJ} may be computed, for example, as follows:

$${t}_{INJ} = {t}_{cycle} \cdot f \qquad ( 5 )$$

where t_{cycle} represents a desired total cycle time or the time between sequential GC measurements and f represents the fraction of time that the injected gas sample is in the precut column versus the main column. The fraction f is generally a constant for a given column configuration. The backflush time t_{BF} may be computed as the difference between the cycle time and the injection time, for example, as follows:

$${t}_{BF} = {t}_{cycle} - {t}_{INJ} \qquad ( 5 )$$

At 212 the GC apparatus may be reconfigured to use the computed optimum parameter values (the optimum temperature computed at 206, the optimum carrier gas flow rate computed at 208, and the optional injection and backflush times computed at 210) when making GC measurements.

FIG. 8 depicts a flow chart of another example GC parameterization method 250. The method includes obtaining a chromatogram for a gas sample at nominal column temperature and carrier gas flow rate settings at 252 (e.g., as described above with respect to method 200 and FIG. 7). The obtained chromatogram may be evaluated at 254 to automatically compute an optimum column temperature, an optimum carrier gas flow rate, and an optimum gas sample injection time, for example, as described above with respect to FIG. 7. The optimum parameters may be set in the GC apparatus at 256 and a further optimization (e.g., quality control check) may be performed at 258 to evaluate and optionally adjust the parameters computed at 256. Performing the quality control check includes acquiring at least one additional chromatogram (a QC chromatogram) and evaluating the chromatogram to determine if further adjustments are required to any one or more of the optimum carrier gas flow rate, the optimum column temperature, and the optimum gas sample injection time.

FIG. 9 depicts a flow chart of one example method 300 for performing the quality control check of the computed parameters at 260 of method 250 in FIG. 8. A first QC chromatogram is obtained at 302 for a gas sample using the computed optimum column temperature and carrier gas flow rate settings determined using one of methods 200 or 250 (FIGS. 7 and 8). As described above, the gas sample may be a calibration sample, for example, including various alkane gases of interest such as a mixture of C1 to C5 or C1 to C8 gases. The quality control method may then proceed as shown on FIG. 9.

At 304, the elution time of the C1 peak may be extracted from the first QC chromatogram and compared with a predetermined C1 threshold range to determine whether or not the C1 elution time is within tolerance limits of the desired elution time. When the C1 elution time is outside of the predetermined or desired C1 threshold range, the previously computed optimum carrier gas flow rate may be adjusted at 306. The optimum carrier gas flow rate may be adjusted manually or automatically, for example, the carrier gas flow rate may be decreased (adjusted downwards) when the C1 elution time is less than the threshold range and may be increased (adjusted upwards) when the C1 elution time is greater than the threshold range. In example embodiments, the optimum carrier gas flow rate may be automatically adjusted by a small predetermined amount. In other example embodiments, the optimum carrier gas flow rate may be adjusted by an amount that is proportional to a difference between the measured and desired C1 elution times, for example, as follows:

$$Δ {V}_{opt} = {K}_{V} Δ {t}_{C 1}$$

where ΔVₒₚₜ represents the adjustment to the optimum carrier gas flow rate, Δt_{C1} represents the difference between the measured and desired C1 elution times, and Ky represents a proportionality constant. The method may then return to 302 to obtain another first QC chromatogram.

When the C1 elution time is within the predetermined range at 304, the elution time of the Cn peak may be extracted from the chromatogram and compared with a predetermined Cn threshold range at 308 to determine whether or not the Cn elution time is within tolerance limits of the desired elution time. When the Cn elution time is outside of the predetermined or desired Cn threshold range, the previously computed optimum column temperature may be adjusted at 310. The optimum column temperature may be adjusted manually or automatically, for example, the column temperature may be decreased (adjusted downwards) when the Cn elution time is less than the threshold range and may be increased (adjusted upwards) when the Cn elution time is greater than the threshold range. In example embodiments, the optimum column temperature may be automatically adjusted by a small predetermined amount. In other example embodiments, the optimum column temperature may be adjusted by an amount that is proportional to a difference between the measured and desired Cn elution times, for example, as follows:

$$Δ {T}_{opt} = {K}_{T} Δ {t}_{C n}$$

where ΔTₒₚₜ represents the adjustment to the optimum column temperature, Δt_{Cn} represents the difference between the measured and desired Cn elution times, and K_{T} represents a proportionality constant. The method may then return to 302 to obtain another first QC chromatogram.

When the Cn elution time is within the predetermined range at 308, a second QC chromatogram may be obtained at 312 using a sample injection time that is greater than the optimum injection time that was used to obtain the first QC chromatogram in 302. First and second peak heights (or amplitudes) of the Cn peaks, An1 and An2, may be extracted from the corresponding first and second QC chromatograms and may be compared at 314. When a difference between the Cn amplitude in the second QC chromatogram, An2, and the Cn amplitude in the first QC chromatogram, An1, exceeds a threshold (i.e., when An2−An1 is less than a threshold), the sample injection time may be increased at 316. Otherwise, the QC procedure may be completed at 318 and the GC parameters may be used in a mud logging operation.

The sample injection time may be adjusted manually or automatically. In example embodiments, the sample injection time may be automatically incremented by a small predetermined amount. In other example embodiments, the sample injection time may be increased by an amount that is proportional to the difference between the Cn peak amplitudes, for example, as follows:

$$Δ {t}_{INJ} = {K}_{INJ} Δ {A}_{C n}$$

where Δt_{INJ} represents the adjustment to the sample injection time, ΔA_{Cn} represents the amplitude difference between the Cn peaks, and KIN represents a proportionality constant. The method may then return to 302 and 312 to obtain another set of first and second QC chromatograms.

It will be appreciated that methods 200, 250, and/300 in FIGS. 7-9 may be advantageously performed at the rig site (e.g., automatically). Moreover, the GC tuning may be performed at substantially any suitable service time interval or whenever it is needed without the need for highly specialized personnel. For example, the GC tuning may be performed at a regular QC interval, for example, at weekly, monthly, bi-monthly, quarterly, semi-annual, or annual intervals depending on the nature of the deployment and/or whenever GC measurements indicate potential changes in the column characteristics.

With continued reference to FIGS. 7-9, it will be appreciated that the gas sample may include substantially any suitable gas sample, but is advantageously a gas sample (such as a calibration sample) including various alkane gases found in downhole oil and gas reservoirs. For example, as noted above, the gas sample may be a calibration sample including a standard calibration mixture of C1, C2, C3, iC4, nC4, iC5, and nC5 gases. In another example, the gas sample may be a calibration sample including a standard calibration mixture of C1 through C8 gases (those of ordinary skill will readily appreciate that in such nomenclature the numeral represents the number of carbon atoms in the alkane gas such that C1 is methane, C2 is ethane, and so on). In advantageous embodiments, the gas sample includes at least C1 and Cn gases, where n is 5, 6, 7, or 8.

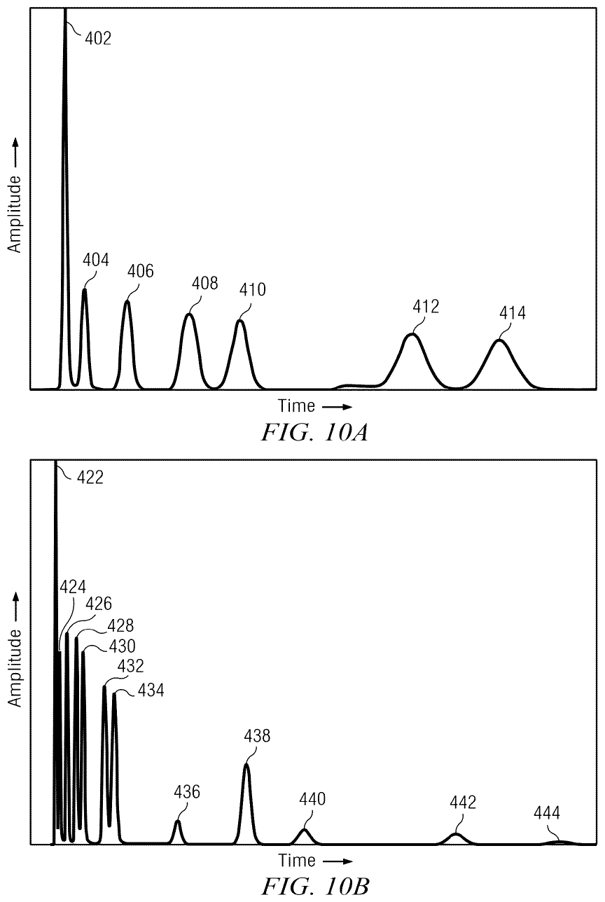

FIGS. 10A and 10B depict example chromatograms obtained with corresponding gas samples including C1-C5 alkane gases (10A) and C1-C8 alkane gases (10B). In the example chromatogram depicted in FIG. 10A, peaks for C1, C2, C3, iC4, nC4, iC5, and nC5 are depicted at 402, 404, 406, 408, 410, 412, and 414. In the example chromatogram depicted in FIG. 10B, peaks for C1, C2, C3, iC4, nC4, iC5, nC5, nC6, benzene, nC7, toluene, and nC8 are depicted at 422, 424, 426, 428, 430, 432, 434, 436, 438, 440, 442, and 444. It will be appreciated that the depicted chromatograms are merely examples and that the disclosed embodiments are not limited to any particular gas sample containing any particular mixture of alkane gases or any particular ratios of gases. Those of ordinary skill in the art are readily able to extract elution times and peak heights for the various ones or all of the gas peaks in the depicted chromatograms.

It will be understood that the present disclosure includes numerous embodiments. These embodiments include, but are not limited to, the following embodiments.

In a first embodiment, a method for tuning operational parameters in a gas chromatography (GC) apparatus at a rig site comprises: providing a GC apparatus at the rig site, the GC apparatus including at least a precut column, a main column, and a detector in fluid communication with the main column, the main column configured to separate light alkane gases in a wellbore gas stream; obtaining a chromatogram of a gas sample using the GC apparatus at prescribed nominal parameter settings, the gas sample comprising at least first and second light alkane gases (C1 and Cn), the prescribed nominal parameter settings including at least a nominal column temperature and a nominal carrier gas flow rate; extracting C1 and Cn elution times from the obtained chromatogram; computing an optimum column temperature from the nominal column temperature and the extracted C1 and Cn elution times; computing an optimum carrier gas flow rate from the nominal carrier gas flow rate, the nominal column temperature, the computed optimum column temperature, and the extracted C1 elution time; and configuring the GC apparatus to make a GC measurements using the computed optimum column temperature and the computed optimum carrier gas flow rate.

A second embodiment may include the first embodiment, wherein the extracting, the computing the optimum column temperature, the computing the optimum carrier gas flow rate, and the configuring the GC apparatus are performed automatically.

A third embodiment may include any one of the first through second embodiments, wherein the computing the optimum column temperature further comprises: computing a measured retention coefficient from the extracted C1 and Cn elution times; computing a desired retention coefficient from desired C1 and Cn elution times; and computing the optimum column temperature from the nominal column temperature, the measured retention coefficient, and the desired retention coefficient.

A fourth embodiment may include the third embodiment, wherein the optimum carrier gas flow rate is computed from the nominal carrier gas flow rate, the nominal column temperature, the computed optimum column temperature, the extracted C1 elution time, and the desired C1 elution time.

A fifth embodiment may include the fourth embodiment, wherein the optimum carrier gas flow rate is computed using the following mathematical relation:

$${V}_{opt} = {{V}^{0} ( \frac{{T}^{0}}{{T}_{opt}} \frac{{t}_{C 1}^{0}}{{t}_{C 1}} )}^{n}$$

wherein Vₒₚₜ represents the optimum carrier gas flow rate, V⁰ represents the nominal carrier gas flow rate, Tₒₚₜ represents the optimum column temperature, T⁰ represents the nominal column temperature,

$${t}_{C 1}^{0} and {t}_{C 1}$$

represent the extracted and desired C1 elution times, and n represents a constant related to the GC apparatus.

A sixth embodiment may include any one of the first through fifth embodiments, further comprising: obtaining a second chromatogram of the gas sample using the GC apparatus at the computed optimum column temperature and the computed optimum carrier gas flow rate; extracting a C1 elution time from the second chromatogram; comparing the extracted C1 elution time from the second chromatogram with a desired C1 elution time range; and adjusting the optimum carrier gas flow rate downwards when the C1 elution time from the second chromatogram is less than the desired C1 elution time range and upwards when the C1 elution time from the second chromatogram is greater than the desired C1 elution time range.

A seventh embodiment may include any one of the first through sixth embodiments, further comprising: obtaining a second chromatogram of the gas sample using the GC apparatus at the computed optimum column temperature and the computed optimum carrier gas flow rate; extracting a Cn elution time from the second chromatogram; comparing the extracted Cn elution time from the second chromatogram with a desired Cn elution time range; and adjusting the optimum column temperature downwards when the Cn elution time from the second chromatogram is less than the desired Cn elution time range and upwards when the Cn elution time from the second chromatogram is greater than the desired Cn elution time range.

An eighth embodiment may include any one of the first through seventh embodiments, further comprising: computing a sample injection time from a desired measurement cycle time and a precut fraction, the precut fraction being a fraction of time that the gas sample is in the precut column; and computing a backflush time as a difference between the desired measurement cycle time and the computed sample injection time.

A ninth embodiment may include the eighth embodiment, further comprising: obtaining a second chromatogram of the gas sample using the GC apparatus at the computed optimum column temperature, the computed optimum carrier gas flow rate, and the computed sample injection time; obtaining a third chromatogram of the gas sample using the GC apparatus at the computed optimum column temperature, the computed optimum carrier gas flow rate, and an injection time that is greater than the computed sample injection time; extracting amplitudes of Cn peaks from the second and third chromatograms; comparing amplitudes of the Cn peaks from the second and third chromatograms; and adjusting the computed sample injection time upwards when the amplitude of the Cn peak from the second chromatogram is less than the amplitude of the Cn peak from the third chromatogram.

A tenth embodiment may include any one of the first through ninth embodiments, wherein the light alkane gases comprise at least C1 through C5 gases and Cn is C5.

An eleventh embodiment may include any one of the first through ninth embodiments, wherein the light alkane gases comprise at least C1 through C8 gases and Cn is C8.

In a twelfth embodiment a gas chromatography (GC) apparatus configured for use on a drilling rig and configured to obtain chromatograms for gas samples containing at least first and second light alkane gases (C1 and Cn) comprises: a precut column, a main column, and a GC detector in fluid communication with the main column; and an electronic controller configured to: obtain a chromatogram of a gas sample at a prescribed nominal column temperature and a prescribed nominal carrier gas flow rate; extract C1 and Cn elution times from the obtained chromatogram; compute an optimum column temperature from the nominal column temperature and the extracted C1 and Cn elution times; compute an optimum carrier gas flow rate from the nominal carrier gas flow rate, the nominal column temperature, the computed optimum column temperature, and the extracted C1 elution time; and reconfigure the GC apparatus to make a GC measurements using the computed optimum column temperature and the computed optimum carrier gas flow rate.

A thirteenth embodiment may include the twelfth embodiment, wherein the electronic controller is configured to automatically compute the optimum column temperature, compute the optimum carrier gas flow rate, and reconfigure the GC apparatus to make a GC measurements using the computed optimum column temperature and the computed optimum carrier gas flow rate.

A fourteenth embodiment may include any one of the twelfth through thirteenth embodiments, wherein the electronic controller is configured to compute the optimum carrier gas flow rate using the following mathematical relation:

$${V}_{opt} = {{V}^{0} ( \frac{{T}^{0}}{{T}_{opt}} \frac{{t}_{C 1}^{0}}{{t}_{C 1}} )}^{n}$$

wherein Vₒₚₜ represents the optimum carrier gas flow rate, V⁰ represents the nominal carrier gas flow rate, Tₒₚₜ represents the optimum column temperature, T⁰ represents the nominal column temperature,

$${t}_{C 1}^{0} and {t}_{C 1}$$

represent the extracted and desired C1 elution times, and n represents a constant related to the GC apparatus.

A fifteenth embodiments may include any one of the twelfth through fourteenth embodiments, wherein the electronic controller is further configured to compute: a sample injection time from a desired measurement cycle time and a precut fraction, the precut fraction being a fraction of time that the gas sample is in the precut column; and a backflush time as a difference between the desired measurement cycle time and the computed sample injection time.

In a sixteenth embodiment a method for tuning operational parameters in a gas chromatography (GC) apparatus at a rig site comprises: providing a GC apparatus at the rig site, the GC apparatus including at least a precut column, a main column, and a detector in fluid communication with the main column, the main column configured to separate at least first and second light alkane gases (C1 and Cn) in a wellbore gas stream; inputting desired C1 and Cn elution times into the GC apparatus; causing the GC apparatus to obtain a chromatogram of a gas sample at prescribed nominal parameter settings, the gas sample comprising at least C1 and Cn alkane gases, the prescribed nominal parameter settings including at least a nominal column temperature and a nominal carrier gas flow rate; automatically extracting C1 and Cn elution times from the obtained chromatogram; automatically computing an optimum column temperature from the nominal column temperature, the extracted C1 and Cn elution times, and the input desired C1 and Cn elution times; automatically computing an optimum carrier gas flow rate from the nominal carrier gas flow rate, the nominal column temperature, the computed optimum column temperature, the extracted C1 elution time, and the desired C1 elution time; and automatically configuring the GC apparatus to make GC measurements using the computed optimum column temperature and the computed optimum carrier gas flow rate.

A seventeenth embodiment may include the sixteenth embodiment, further comprising: causing the GC apparatus to obtain a second chromatogram of the gas sample using the computed optimum column temperature and the computed optimum carrier gas flow rate; automatically extracting a C1 elution time from the second chromatogram; automatically comparing the extracted C1 elution time from the second chromatogram with the desired C1 elution time; and automatically adjusting the optimum carrier gas flow rate when a difference between extracted C1 elution time from the second chromatogram and the desired C1 elution time exceeds a threshold.

An eighteenth embodiment may include the seventeenth embodiment, further comprising: extracting a Cn elution time from the second chromatogram; comparing the extracted Cn elution time from the second chromatogram with a desired Cn elution time; and adjusting the optimum column temperature when a difference between the Cn elution time from the second chromatogram and the desired Cn elution time exceeds a threshold.

A nineteenth embodiment may include the eighteenth embodiment, further comprising: computing a sample injection time from a desired measurement cycle time and a precut fraction, the precut fraction being a fraction of time that the gas sample is in the precut column, wherein the second chromatogram is obtained using the computed sample injection time; causing the GC apparatus to obtain a third chromatogram of the gas sample using the computed optimum column temperature, the computed optimum carrier gas flow rate; and an injection time that is greater than the computed sample injection time; automatically extracting amplitudes of Cn peaks from each of the second and third chromatograms; comparing the extracted amplitudes of the Cn peaks from the second and third chromatograms; and adjusting the computed sample injection time upwards when the amplitude of the Cn peak from the second chromatogram is less than the amplitude of the Cn peak from the third chromatogram.

A twentieth embodiment may include any one of the sixteenth through nineteenth embodiments, wherein the light alkane gases comprise: at least C1 through C5 gases and Cn is C5; or at least C1 through C8 gases and Cn is C8.

Although automatic tuning of a rig site gas chromatograph has been described in detail, it should be understood that various changes, substitutions and alternations can be made herein without departing from the spirit and scope of the disclosure as defined by the appended claims.

1. A method for tuning operational parameters in a rig site gas chromatography (GC) apparatus, the method comprising:
providing a GC apparatus at the rig site, the GC apparatus including at least a precut column, a main column, and a detector in fluid communication with the main column, the main column configured to separate light alkane gases in a wellbore gas stream;
obtaining a chromatogram of a gas sample using the GC apparatus at prescribed nominal parameter settings, the gas sample comprising at least first and second light alkane gases (C1 and Cn), the prescribed nominal parameter settings including at least a nominal column temperature and a nominal carrier gas flow rate;
extracting C1 and Cn elution times from the obtained chromatogram;
computing an optimum column temperature from the nominal column temperature and the extracted C1 and Cn elution times;
computing an optimum carrier gas flow rate from the nominal carrier gas flow rate, the nominal column temperature, the computed optimum column temperature, and the extracted C1 elution time; and
configuring the GC apparatus to make a GC measurements using the computed optimum column temperature and the computed optimum carrier gas flow rate.

2. The method of claim 1, wherein the extracting, the computing the optimum column temperature, the computing the optimum carrier gas flow rate, and the configuring the GC apparatus are performed automatically.

3. The method of claim 1, wherein the computing the optimum column temperature further comprises:
computing a measured retention coefficient from the extracted C1 and Cn elution times;
computing a desired retention coefficient from desired C1 and Cn elution times; and
computing the optimum column temperature from the nominal column temperature, the measured retention coefficient, and the desired retention coefficient.

4. The method of claim 3, wherein the optimum carrier gas flow rate is computed from the nominal carrier gas flow rate, the nominal column temperature, the computed optimum column temperature, the extracted C1 elution time, and the desired C1 elution time.

5. The method of claim 4, wherein the optimum carrier gas flow rate is computed using the following mathematical relation:
$${V}_{opt} = {{V}^{0} ( \frac{{T}^{0}}{{T}_{opt}} \frac{{t}_{C 1}^{0}}{{t}_{C 1}} )}^{n}$$
wherein Vₒₚₜ represents the optimum carrier gas flow rate, V⁰ represents the nominal carrier gas flow rate, Tₒₚₜ represents the optimum column temperature, T⁰ represents the nominal column temperature,
$${t}_{C 1}^{0} and {t}_{C 1}$$
represent the extracted and desired C1 elution times, and n represents a constant related to the GC apparatus.

6. The method of claim 1, further comprising:
obtaining a second chromatogram of the gas sample using the GC apparatus at the computed optimum column temperature and the computed optimum carrier gas flow rate;
extracting a C1 elution time from the second chromatogram;
comparing the extracted C1 elution time from the second chromatogram with a desired C1 elution time range; and
adjusting the optimum carrier gas flow rate downwards when the C1 elution time from the second chromatogram is less than the desired C1 elution time range and upwards when the C1 elution time from the second chromatogram is greater than the desired C1 elution time range.

7. The method of claim 1, further comprising:
obtaining a second chromatogram of the gas sample using the GC apparatus at the computed optimum column temperature and the computed optimum carrier gas flow rate;
extracting a Cn elution time from the second chromatogram;
comparing the extracted Cn elution time from the second chromatogram with a desired Cn elution time range; and
adjusting the optimum column temperature downwards when the Cn elution time from the second chromatogram is less than the desired Cn elution time range and upwards when the Cn elution time from the second chromatogram is greater than the desired Cn elution time range.

8. The method of claim 1, further comprising
computing a sample injection time from a desired measurement cycle time and a precut fraction, the precut fraction being a fraction of time that the gas sample is in the precut column; and
computing a backflush time as a difference between the desired measurement cycle time and the computed sample injection time.

9. The method of claim 8, further comprising:
obtaining a second chromatogram of the gas sample using the GC apparatus at the computed optimum column temperature, the computed optimum carrier gas flow rate, and the computed sample injection time;
obtaining a third chromatogram of the gas sample using the GC apparatus at the computed optimum column temperature, the computed optimum carrier gas flow rate, and an injection time that is greater than the computed sample injection time;
extracting amplitudes of Cn peaks from the second and third chromatograms;
comparing amplitudes of the Cn peaks from the second and third chromatograms; and
adjusting the computed sample injection time upwards when the amplitude of the Cn peak from the second chromatogram is less than the amplitude of the Cn peak from the third chromatogram.

10. The method of claim 1, wherein the light alkane gases comprise at least C1 through C5 gases and Cn is C5.

11. The method of claim 1, wherein the light alkane gases comprise at least C1 through C8 gases and Cn is C8.

12. A gas chromatography (GC) apparatus configured for use on a drilling rig and configured to obtain chromatograms for gas samples containing at least light alkane gases, the apparatus comprising:
a precut column, a main column, and a GC detector in fluid communication with the main column; and
an electronic controller configured to:
obtain a chromatogram of a gas sample at a prescribed nominal column temperature and a prescribed nominal carrier gas flow rate;
extract C1 and Cn elution times from the obtained chromatogram;
compute an optimum column temperature from the nominal column temperature and the extracted C1 and Cn elution times;
compute an optimum carrier gas flow rate from the nominal carrier gas flow rate, the nominal column temperature, the computed optimum column temperature, and the extracted C1 elution time; and
reconfigure the GC apparatus to make a GC measurements using the computed optimum column temperature and the computed optimum carrier gas flow rate.

13. The GC apparatus of claim 12, wherein the electronic controller is configured to automatically compute the optimum column temperature, compute the optimum carrier gas flow rate, and reconfigure the GC apparatus to make a GC measurements using the computed optimum column temperature and the computed optimum carrier gas flow rate.

14. The GC apparatus of claim 12, wherein the electronic controller is configured to compute the optimum carrier gas flow rate using the following mathematical relation:
$${V}_{opt} = {{V}^{0} ( \frac{{T}^{0}}{{T}_{opt}} \frac{{t}_{C 1}^{0}}{{t}_{C 1}} )}^{n}$$
wherein Vₒₚₜ represents the optimum carrier gas flow rate, V⁰ represents the nominal carrier gas flow rate, Tₒₚₜ represents the optimum column temperature, T⁰ represents the nominal column temperature,
$${t}_{C 1}^{0} and {t}_{C 1}$$
represent the extracted and desired C1 elution times is a known constant, and n represents a constant related to of the GC apparatus.

15. The GC apparatus of claim 12, wherein the electronic controller is further configured to compute:
a sample injection time from a desired measurement cycle time and a precut fraction, the precut fraction being a fraction of time that the gas sample is in the precut column; and
a backflush time as a difference between the desired measurement cycle time and the computed sample injection time.

16. A method for tuning operational parameters in a gas chromatography (GC) apparatus at a rig site, the method comprising:
providing a GC apparatus at the rig site, the GC apparatus including at least a precut column, a main column, and a detector in fluid communication with the main column, the main column configured to separate light alkane gases in a wellbore gas stream;
inputting desired C1 and Cn elution times into the GC apparatus;
causing the GC apparatus to obtain a chromatogram of a gas sample at prescribed nominal parameter settings, the gas sample comprising at least C1 and Cn alkane gases, the prescribed nominal parameter settings including at least a nominal column temperature and a nominal carrier gas flow rate;
automatically extracting C1 and Cn elution times from the obtained chromatogram;
automatically computing an optimum column temperature from the nominal column temperature, the extracted C1 and Cn elution times, and the input desired C1 and Cn elution times;
automatically computing an optimum carrier gas flow rate from the nominal carrier gas flow rate, the nominal column temperature, the computed optimum column temperature, the extracted C1 elution time, and the desired C1 elution time; and
automatically configuring the GC apparatus to make GC measurements using the computed optimum column temperature and the computed optimum carrier gas flow rate.

17. The method of claim 16, further comprising:
causing the GC apparatus to obtain a second chromatogram of the gas sample using the computed optimum column temperature and the computed optimum carrier gas flow rate;
automatically extracting a C1 elution time from the second chromatogram;
automatically comparing the extracted C1 elution time from the second chromatogram with the desired C1 elution time; and
automatically adjusting the optimum carrier gas flow rate when a difference between extracted C1 elution time from the second chromatogram and the desired C1 elution time exceeds a threshold.

18. The method of claim 17, further comprising:
extracting a Cn elution time from the second chromatogram;
comparing the extracted Cn elution time from the second chromatogram with a desired Cn elution time; and
adjusting the optimum column temperature when a difference between the Cn elution time from the second chromatogram and the desired Cn elution time exceeds a threshold.

19. The method of claim 18, further comprising
computing a sample injection time from a desired measurement cycle time and a precut fraction, the precut fraction being a fraction of time that the gas sample is in the precut column, wherein the second chromatogram is obtained using the computed sample injection time;
causing the GC apparatus to obtain a third chromatogram of the gas sample using the computed optimum column temperature, the computed optimum carrier gas flow rate; and an injection time that is greater than the computed sample injection time;
automatically extracting amplitudes of Cn peaks from each of the second and third chromatograms;
comparing the extracted amplitudes of the Cn peaks from the second and third chromatograms; and
adjusting the computed sample injection time upwards when the amplitude of the Cn peak from the second chromatogram is less than the amplitude of the Cn peak from the third chromatogram.

20. The method of claim 16, wherein the light alkane gases comprise:
at least C1 through C5 gases and Cn is C5; or
at least C1 through C8 gases and Cn is C8.
